(19) United States
(12) Patent Application Publication
(10) Pub. No.: US 2025/0317703 A1
(43) Pub. Date: Oct. 9, 2025

(54) SYSTEMS AND METHODS FOR MULTIVIEW AUDIO PRESENTATION

(71) Applicant: VIZIO, INC., Irvine, CA (US)

(72) Inventors: William Wang, Irvine, CA (US); Craig Liebel, Irvine, CA (US)

(73) Assignee: VIZIO, INC., Irvine, CA (US)

(21) Appl. No.: 19/098,766

(22) Filed: Apr. 2, 2025

Related U.S. Application Data
(60) Provisional application No. 63/631,816, filed on Apr. 9, 2024.

(51) Int. Cl. H04S 7/00

(52) U.S. Cl. CPC H04S 7/302; H04S 2400/11; H04S 2400/13; H04S 2420/01

(57) ABSTRACT

A display device may define a multivew media presentation including two or more media segments presented simultaneously. The two or more media segments may be presented in a grid pattern with a first media segment presented at a first location of the display device. The display device may receive a selection of the first media segment of the two or more media segments. In response, the display device may modify the audio component of the first media segment based on the first location of the first media segment. The modification to the audio component may cause the modified audio component to be perceived by a user as originating at the first location of the display device. The display device may then present modified audio component of the first media segment.

### CROSS-REFERENCE TO RELATED APPLICATIONS

The present patent application claims the benefit of priority to U.S. Provisional Patent Application No. 63/631,816 filed Apr. 9, 2024, which is incorporated herein by reference in its entirety for all purposes.

### TECHNICAL FIELD

This disclosure relates generally to audio processing, and more particularly to generating simulated spatial audio synchronized to according to a positioning of corresponding video.

### BACKGROUND

Generally, the audio component of media is presented proximate to the corresponding video component. The spatial proximity of the audio and video components improves the perception of the media and semantic understanding because the audio component is coming from the same direction relative to the user as the presentation of the video component. When the presentation of the audio component is separated from the video component (e.g., spatial desynchronization), the audio component may be perceived as originating from a different location than the video component. The impact of spatial desynchronization may be jarring to the user similar to when the audio component and the video component are desynchronized. The impact may be exacerbated when multiple media segments are presented simultaneously.

### SUMMARY

Methods are described herein for processing the audio component of media to synchronize the spatial perception of the audio component with the spatial location of the video component. The methods can include presenting, by a display device, two or more media segments simultaneously, wherein a first media segment of the two or media segments is presented at a first location of the display device; receiving a selection of the first media segment of the two or more media segments; modifying an audio component of the first media segment based on the first location of the first media segment, wherein the modified audio component is configured to be perceived by a user as originating at the first location of the display device; and facilitating a presentation of the modified audio component of the first media segment.

Systems are described herein for processing the audio component of media to synchronize the spatial perception of the audio component with the spatial location of the video component. The systems may include one or more processors and a non-transitory computer-readable medium storing instructions that, when executed by the one or more processors, cause the one or more processors to perform any of the methods as previously described.

Non-transitory computer-readable media are described herein for storing instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example computing device configured to synchronize the spatial perception of an audio component with the spatial location of a video component according to aspects of the present disclosure.

FIG. 2 illustrates an example of modifications to an audio component of media to synchronize with spatial perception of the audio component with the spatial location of a video component during a multiview presentation according to aspects of the present disclosure.

FIG. 3 illustrates a block diagram of an example audio processor for multiview presentation according to aspects of the present disclosure.

FIG. 4 illustrates a block diagram of an example audio processor for multiview presentation with height virtualization according to aspects of the present disclosure.

FIG. 5 illustrates a block diagram of another example audio processor for multiview presentation with height virtualization according to aspects of the present disclosure.

FIG. 6 illustrates an example circuit diagram of an audio processor configured for multiview presentation with height virtualization according to aspects of the present disclosure.

FIG. 7 illustrates a flowchart of an example process for processing the audio component of media to synchronize the spatial perception of the audio component with a video component according to aspects of the present disclosure.

FIG. 8 illustrates an example computing device architecture of an example computing device that can implement the various techniques described herein according to aspects of the present disclosure.

### DETAILED DESCRIPTION

Methods and systems are presented herein for an audio processor configured to generate spatially-perceptible audio synchronized to the spatial location of corresponding video. The presentation of media may be impacted based on the location of the presentation of the audio (e.g., the speakers of the media device and/or connected to the media device) relative to the location of the presentation of the video. The impact may be greater when multiple media segments are presented at a same time (e.g., multiview media, picture-in-picture media, etc.) where it may be difficult to determine which media segment corresponds to the audio being presented. The methods and systems presented herein including an audio processor that modifies the audio channel of media so that the audio channel is perceived as coming from the spatial location in which the corresponding video channel is being presented. The modified audio channel may provide improved perception and parsing of media especially for multiview media and media presented from unconventional spatial locations (e.g., above, below, and/or to the left or right of a user).

A media device (e.g., a device configured to present video and audio such as, but not limited to, a television, computing device, mobile device such as a smartphone or tablet, billboard, etc.) may be configured to present one or more media segment at a same time (e.g., referred to herein as multiview media). Each media segment of the one or more media segments may located at a predetermined location of the screen based on the quantity of media segments being displayed, the resolution of each media segment and/or the display device, etc. In some examples, the media segments be a same width and height (e.g., as a square or rectangular shape, etc.) and presented in a grid-pattern. In other examples, the media segments may of varying shapes and/or sizes based on the media being presented, a machine-learning model (e.g., such as a general pre-trained transformer, neural network, deep learning model, etc.), user input, combinations thereof, and/or the like. In those examples, the orientation of the media segments relative to other media segments being presented may also be based on the media being presented, the machine-learning model, user input, combinations thereof, and/or the like. For example, a user may select one or more channels to be presented by the media device at the same time. The user (and/or the media device) may determine the location of the media device in which the media of each channel is to be presented.

The media device may present the audio channel of one or more selected media segments of the one or more media segments being simultaneously presented. The media device may then mute any of the non-selected media segments of the one or more media segments. Alternatively, the media device may randomly select a media segment of the one or more media segment and mute other media segments of the one or more media segments. For example, if a user is requests multiple sports games be presented at once, the resulting combined audio of the multiple sports games may be unintelligible. The media device may enable selection of particular media segments during multiview where only the audio component of the selected media segment is presented. The user may select a new media segment of the one or more media segments causing the media device to mute the original media segment and begin presenting the audio channel of the new media segment. In some examples, the media segment may highlight the one or more selected media segments to provide a visual indicator of the one or more selected media segments relative to the non-selected media segments. The visual indicator may include a border, increasing a size of the one or more selected media segments (e.g., a slight increase, to a 2× increase, to a full screen of the media device, etc.), blurring non-selected media segments, spatially processing the audio channel of the one or more selected media segments so that the audio channel is perceived as originating from the location of the one or more selected media segments on the media device, combinations thereof, and/or the like.

For example, upon selecting a particular media segment from the one or more media segments being simultaneously presented, the media device may mute the other media segments (e.g., media segments of the one or more media segments other than the particular media segment, etc.). The media device may then modify audio channel of the particular media segment using an audio processor of the media device. The audio processor may be hardware component (e.g., central processing unit, microcontroller, field programmable gate array, application specific integrated circuit, integrated circuit, etc.) and/or software component (e.g., an application, machine-learning model, and/or other code) configured to receive the audio channel of the particular media segment and modify the audio channel so that the audio channel will be perceived by the user as if originating at the spatial location of the media device that is presenting the corresponding video channel of the media segment. Examples of modifications to the audio channel may include, but are not limited to, converting the audio channel to monaural, converting the audio channel to stereo, removing a left audio channel, removing a right audio channel, modifying the right audio channel using a head-related transfer function, modifying the left audio channel using a head-related transfer function, modifying a volume of the audio channel (e.g., to enable a perception that the audio is closer to the user or further from the user, etc.), adding or removing audio being presented over the audio channel (e.g., adding or removing audio corresponding to one or more video segments), filtering the audio channel (e.g., dynamically defined bandpass filtering), combinations thereof, and/or the like.

The media device may use a location of the user relative to a display of the media device and/or the location of the speakers of the media device relative to the display of the media device to determine modifications to the audio channel of the particular media segment. In some examples, the location of the user may be predetermined (e.g., based on average media device height, average viewing distance, average view distance, etc.) based on the size of the display, etc. In other instance, the location of the user may be dynamically determined using sensor data from one or more sensors of the media device such as a Received Signal strength Indicator (RSSI) from Bluetooth or Wi-Fi signals between the media device and device proximate to the user, a camera of the media device, an infrared sensor of the display device, light or laser sensor of the display device, microphone of the display device (e.g., where the location may be inferred from speech from the user, ambient sound, or other sounds, etc.), combinations thereof, or the like. In still yet other instances, user input may be used to define a location of the user (e.g., alone or in combination with the predetermined location and/or one or more sensors). In some instances, the media device may use other information associated with the media device and/or the user such as, but not limited to, a volume setting, demographic information associated with the user (e.g., age, sex, location, etc.), device information (e.g., device identifier, device processing capabilities, etc.), network information (e.g., Internet Protocol address; media access control address; connection information such as signal strength; connection frequency; channel, etc.; network configuration; etc.), combinations thereof, and/or the like. The other information may be used to derive features usable to determine the location of the user. For example, the user's age and the current volume setting may be used to infer a distance (e.g., expressed as time distance, radial distance, in feet or meters, etc.) between the media device and the user.

The location may be an expressed using one or more parameters using a spherical coordinate system or other coordinate system. In some instances, the one or more parameters may be based on the user as being an origin of the coordinate system. In other instances, the one or more parameters may be based on the display of the media device or the speakers of the media device being the origin of the coordinate system. The parameters may include, but are not limited to, elevation (e.g., the vertical angle, θ, corresponding to the direction of the display of the media device above or below the user), azimuth (e.g., the horizontal angle, φ, corresponding the direction of the display of the media device to the left or to the right of the user), radius (e.g., the radial distance, r, between the display of the media device and the user), and the like.

In some examples, the parameters may be derived from the sensor data and/or other information using one or more algorithms and/or tables (e.g., where one or more sensor measurements may correspond to a parameter value, etc.). Alternatively, the parameters may be derived using a machine-learning model. Examples of machine-learning models or machine-learning algorithms include, but are not limited to, neural networks (recurrent neural networks such as long short term memory (LSTM), etc.; convolutional neural networks such as you only look once (YOLO), etc.; or the like), support vector machines, Naïve Bayes, k-nearest neighbor, linear or non-linear regression models, gradient-boosted decision trees, etc.), spatial clustering of applications with noise (DBSCAN), linear classification, hierarchical clustering, k-means clustering, fuzzy c-means (FCM), expectation-maximization (EM), and/or the like. More generally, machine learning or artificial intelligence methods may include regression analysis, dimensionality reduction, metalearning, reinforcement learning, deep learning, and other such algorithms and/or methods.

The media device may include a pre-trained machine-learning model, access a trained machine-learning model stored remotely (e.g., such as in a computing device, server, etc.), and/or the like. Alternatively, the media device may train the machine-learning model. The machine-learning model may be trained using supervised learning, unsupervised learning, semi-supervised learning, transfer learning, reinforcement learning, combinations thereof, or the like. The computing device may train the machine-learning model for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like). The machine-learning model may receive a feature vector derived from sensor data (e.g., normalized, unnormalized, etc.), other information, user input, and/or the like. The machine-learning model may be configured to output the parameters.

The media device may modify the audio channel of the particular media segment based on the location of the user relative to the display of the media device and/or the location of the speakers relative to the display of the media device. The location of the speakers of the media device relative to the display of the media device may be predetermined when using internal speakers of the media device and determined using any of the aforementioned ways of determining the location of the user. The modification to the audio channel may a combination of left/right channel selection and executing a head-related transfer function. The audio processor may reduce the right audio channel so that the user perceived the audio channel as originating to the left of the user. The greater the reduction to the right audio channel the further to the left the audio channel will be perceived to the user. The audio processor may reduce the left audio channel so that the user perceived the audio channel as originating to the right of the user. The greater the reduction to the left audio channel the further to the right the audio channel will be perceived to the user.

A head-related transfer function (HRTF) is a response that characterizes how an ear receives a sound from a point in space by considering various physical characteristics of a user's ears as well as psychoacoustic perception. In binaural listening, HRTFs may determine audio perception in three dimensions (e.g., a point in three-dimensional space from which specific sounds come from, etc.). HRTFs can be implemented as audio processing blocks to simulate sound source locations (e.g., to create sound that is perceived to be originating from a different location than the actual source of the sound, etc.). An implementation of an HRTF may use one or more of the parameters as, azimuth, elevation, and radian distance, etc. In some instances, the parameters for the HRTF may be derived based on the location of the user. In those instances, the parameters for the HRTF may be derived from user input, the sensor data, the other information, etc. using one or more algorithms, tables, the machine-learning model, etc.). In other instances, the parameters may not use a derived location of the user (e.g., the location of the user may be estimated or predetermined based on a size of the media device, the location of the speakers of the media device relative to the display device may be used in place of the location of the user, or the like). The media device may use HRTFs to modify the perceived origin of the audio channel such as modifying the elevation origin (e.g., causing the audio channel to be perceived as originating above or below the user), the azimuth (e.g., causing the audio channel to be perceived as originating to the left or to the right of the user), the distance (e.g., causing the audio channel to be perceived as originating closer to the user or further from the user, etc.), combinations thereof, and/or the like.

In some instances, the media device may use the location of the speakers relative to the display of the media device when implementing a HRTF. The media device may then determine when to use HRTF to modify the perceived originating height of the audio channel. For example, if the speakers of the media device are below or at the bottom of the display of the media device, then media device need not implement HRTF when presenting media segments at the bottom portion of the media device (e.g., due to the proximity to the speakers). Similarly, if the speakers are on top of or at the top of the display of the media device, then media device need not implement HRTF when presenting media segments at the upper portion of the media device. The media device may scale the implementation of HRTF based on the height of the presentation of the particular media segment on the display of the media device relative to the location of the speakers of the media device. If the speakers are not proximate to the media device, then the directional distance of the speakers relative to the display of the media device may be determined and used to determine the application of HRTF.

The media device may combine the application of left/right audio channel selection with HRFT to direct the perception of the audio channel. For example, if the particular media segment is being presented on the top left portion of the display of the media device and the speakers of the media device are proximate to the bottom portion of the display, then the media device may modify the audio channel of the particular media segment by reducing the right channel to zero so that the audio channel will be perceived as originating from the left portion of the display. The media device may also implement a HRTF to raise the perceived originating height of the audio channel to correspond with the upper portion of the display. The combination of the left/right channel selection and HRTF enables the media device to present an audio channel that is perceived as originating from the location of the display from which the corresponding video channel of the media segment is being presented.

The media device may receive a selection of a new media segment of the one or more media segments. In response, the media device may modify the current presentation of the media device. For example, the media device may mute the particular media segment, and begin presenting the audio channel of the new media segment. The audio channel of the new media segment may be modified based on the presentation location of the new media segment on the display of media device using left/right channel selection and/or HRTF as previously described. Alternatively, the media device may be presenting the new media segment using the full display of the media device (e.g., full screen, etc.), in place of the other media segments of the one or more media segments. The media device may bypass the audio processor to prevent modifying the audio channel of the new media segment.

In an illustrative example, a display device (e.g., a device configured to present video and audio such as, but not limited to, a television, computing device, mobile device such as a smartphone or tablet, billboard, etc.) may generate a multiview media presentation in which two or more media segments may be presented by the display device simultaneously. Each media segment may be presented using a portion of the display device of n pixels (e.g., comprising a resolution of x pixels by y pixels). The two or more media segments be a uniform size (e.g., a same resolution) or of varying sizes. The media device may present the two or more media segments in a grid pattern with the two or more media segments presented in one or more rows of media segments. Alternatively, the two or more media segments may be presented in a different orientation (e.g., according to user selected locations on the display device, etc.). A first media segment of the two or media segments may be presented at a first location of the display device.

The display device may receive a selection of the first media segment of the two or more media segments. The display device may enable one or more operations to be executed in association with a media segment of the two or more media segments. The display device may receive a selection of any media segment of the two or more media segments and an identification of an operation to execute in association with the selected media segment. Examples of operations include, but are not limited to, modifying a resolution of the video component of the media segment, modifying a refresh rate of the video component, modifying a size of the presentation of the video component, modifying a frame rate of the video segment, modifying a brightness or contrast of the video component, modifying pixel values of pixels of the video component, converting an audio component of the media segment to monaural, converting the audio component to stereo, removing a left audio component, removing a right audio component, modifying the right audio component using a head-related transfer function, modifying the left audio component using a head-related transfer function, modifying a volume of the audio component (e.g., to enable a perception that the audio is closer to the user or further from the user, etc.), adding or removing audio being presented over the audio component (e.g., adding or removing audio corresponding to one or more video segments), filtering the audio component (e.g., dynamically defined bandpass filtering), combinations thereof, and/or the like.

In some instances, when presenting multiveiw media, the display device may include a default operation associated with the selection of a media segment. For instance, selecting the first media segment of the two or more media segments may cause the display device to modify the audio component of the first media segment to generate a localized audio. Localized audio may include muting other media segments (e.g., media segments other than the first media segment) and modifying the audio component of the first media segment so that the modified audio component will be perceived by the user of the display device as originating at the first location of the display device in which the first media segment is being presented. The display device may execute one or more other operations in addition to the localized audio such as modifying the presentation of the first media segment to provide an indication that the first media segment has been selected. For example, the media device may modify a size of the first media segment, add a border around the first media segment, add a symbol to the first media segment to indicate the first media segment is selected, remove a symbol to indicate the first media segment is selected, modify a frame rate of the first media segment (e.g., increase or decrease the frame rate, etc.), combinations thereof, and/or the like.

The display device may modify an audio component of the first media segment based on the first location of the first media segment. The modified audio component is configured to be perceived by a user as originating at the first location of the display device. The modification to the audio component may be determined based on the location of the speakers relative to the display device and/or the location of the user relative to the display device. In some instances, the location of the speakers may be predetermined such as when the speakers are built into the display device or proximate to the display device (e.g., such as a sound bar, etc.). In other instances, the location of the speakers may be determined based on user input (e.g., the user may identify the location of the speakers relative to the display device). In still yet other instances, the location of the speakers may be determined using sensors of the display device. For instance, the display device may detect audio presented by a speaker using a microphone and determine the relative location of the speaker based on the detected audio. Alternatively or additionally, the display device may use other sensors such as, but not limited to, microphones, cameras, transceivers (e.g., to perform triangulation, RSSI, etc.), combinations thereof, and/or the like. The display device may use one or more location algorithms and/or a trained machine-learning model (e.g., as previously described) to identify the location of each speaker.

In some instances, the location of the user may be predetermined based on average viewing distances and angles and the size of the display device. In other instances, the location of the user may be determined based on user input (e.g., the user may identify the location of the user relative to the display device). In still yet other instances, the location of the user may be determined using sensors of the display device. For instance, the display device may detect audio presented the user using a microphone and determine the relative location of the user based on the detected audio. Alternatively or additionally, the display device may use other sensors such as, but not limited to, microphones, cameras, transceivers (e.g., to perform triangulation, RSSI, etc. of a device proximate to the user, etc.), combinations thereof, and/or the like. The display device may use one or more location algorithms and/or a trained machine-learning model (e.g., as previously described) to identify the location of the user. The display device may determine a horizontal modification and a vertical modification to the audio component.

The display device may define a horizontal modification to the audio component and a vertical modification to the audio component. The horizontal modification may be determined based on the location of first media segment, the location of the speakers, and/or the location of the user. For instance, if the first media segment is on a left portion of the display device, then the display device may present only the left channel of the audio component so that the audio is perceived as coming from the left portion of the display device. For media segments that are being presented closer to the middle of the display device but still on one side of the display device, the display device may reduce a portion of the opposing channel. For instance, if the display device is presented four media segments in a row, then selecting the left most media segment may cause the display device to reduce the right audio channel to zero. Selecting the second media segment from the left (e.g., closer to the middle of the display device, but still on the left side), the media device may reduce the right audio channel by a predetermined quantity based on the distance the center of the media segment is from the middle of the display device (and optionally reduce the left channel by an amount). Selecting the right most media segment may cause the display device to reduce the left audio channel to zero. Selecting the second media segment from the right (e.g., closer to the middle of the display device, but on the right side), the media device may reduce the left audio channel by a predetermined quantity based on the distance the center of the media segment is from the middle of the display device (and optionally reduce the right channel by an amount). For example, the second media segment from the left may have a right audio channel presenting at 25% of the audio (e.g., at a volume level that is 25% of a current volume level) and the left audio channel presenting at 75% (at a volume level that is 75% of the current volume level).

The display device may define a vertical modification to the audio component using a head-related transfer function using parameters derived from the location of the user. The head-related transfer function may use a monaural version of the audio component. In some instances, the display device may convert the audio component into a mono before implementing the head-related transfer function. The parameters may include, but are not limited to, elevation, azimuth, distance, etc. In some examples, the display device may use a machine-learning model (e.g., such as the previously described machine-learning model and/or another machine-learning model to derive the head-related transfer function. The output of the head-related transfer function may be a translation of the audio component in the vertical plane to cause the audio component to be perceived as originating on an upper portion of the display device or a lower portion of the display device.

The modified audio component may be a combination of the vertical modification (e.g., the output from the head-related transfer function) as adjusted horizontally using the horizontal modification to the audio component. Alternatively, the head-related transfer function may be configured to derive both the vertical modification and the horizontal modification. In those instances, the frequency and intensity of the audio component may be defined to cause the modified audio component to be perceived as originating at the first location of the display device without adjusting the left or right audio channels.

The display device may facilitate a presentation of the modified audio component of the first media segment. The presentation of the modified audio channel may be perceived by the user as originating at the first location of the display device.

The display device may receive a selection of a new media segment and in response mute the audio component of the first media segment and modify the audio component of the new media segment based on the location of the presentation of the new media segment on the display device. The modified audio component of the new media segment may be perceived by the user as originating at the location of the presentation of the new media segment on the display device. The process may continue until the multiview media presentation is terminated or the display device is powered off.

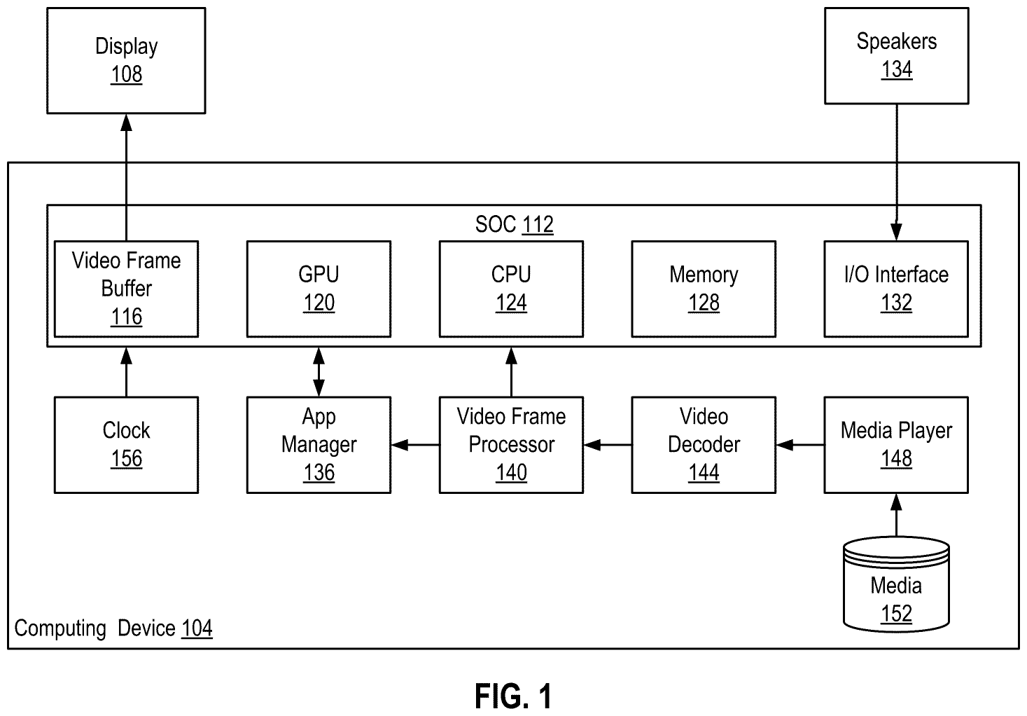

FIG. 1 illustrates a block diagram of an example computing device configured to synchronize the spatial perception of an audio component with the spatial location of a video component according to aspects of the present disclosure. Computing device 104 may include one or processing components (e.g., system-on-a-chip, central processing units, application-specific integrated circuits, field programmable gate arrays, and/or the like), memories (e.g., volatile and non-volatile memories, databases, etc.), network processors (e.g., including Wi-Fi transceivers, Bluetooth transceivers, and/or other transceivers, etc.), and one or more sensors (e.g., cameras, microphones, optical sensors, etc.).

Computing device 104 may be configured to present media to one or more users using display 108 and/or one or more wireless devices connected via a network processor (e.g., such as other display devices, mobile devices, tablets, and/or the like). Computing device 104 may retrieve the media from media database 152 (or alternatively receiving media from one or more broadcast sources, a remote source via a network processor, an external device, etc.). The media may be loaded by media player 148, which may process the media based on the container of the video (e.g., MPEG-4, QuickTime Movie, Wavefile Audio File Format, Audio Video Interleave, etc.). Media player 148 may pass the media to video decoder 144, which decodes the video into a sequence of video frames that can be displayed by display 108. The sequence of video frames may be passed to video frame processor 140 in preparation for display. Alternatively, media may be generated by an interactive service operating within app manager 136. App manager 136 may pass the sequence of frames generated by the interactive service to video frame processor 140.

The sequence of video frames may be passed to system-on-a-chip (SOC) 112. SOC 112 may include processing components configured to enable the presentation of the sequence of video components and/or audio components. SOC 112 may include central processing unit (CPU) 124, graphics processing unit (GPU) 120, memory 128 (e.g., volatile memories such as random-access memory or read-only memory, non-volatile memory (e.g., such as magnetic, flash, etc.), input/output interfaces 132, and video frame buffer 116.

For multiview media presentations, video frame processor 140 may receive a sequence of frames for each of one or more media segments. Video frame processor 140 may scale the size of the one or more frames down based on the quantity of video segments to be presented at the same time. Video frame processor 140 may generate a single sequence of frames from the sequences of frames of each of the one or more media segments with the single sequence of frames including a same quantity of frames as the sequences of frames of the one or more media segments. Each fame of the single sequence of frames may include the scaled down frame of each media segment of the one or more media segments. Alternatively, video frame processor 140 may process the sequences of frames of the one or more media segments in parallel. By processing the sequences of frames in parallel (rather than defining a single sequence of frames), computing device 104 may process each sequence of frames of a media segment of the one or more media segments separately enabling each media segment to be presented with a different resolution, refresh rate, frame rate, etc.

In some instances, SOC 112 may identify media segments being presented as well as media segments that are currently being presented by other channels accessible to SOC 112. SOC 112 may identify media segments by receiving scheduling data or metadata over the channel or the Internet (e.g., for streaming content, etc.), receiving scheduling data or metadata from a content provider (e.g., cable or satellite provider, content delivery network, etc.), and/or receiving scheduling data or metadata from one or more other sources.

Alternatively, or additionally, SOC 12 may identify media segments based on pixel data or audio data received of the media segment. SOC 112 may generate a cue from one or more video fames stored in video frame buffer 116 prior to or as the one or more video frames are presented by display 108. A cue may be generated from one or more pixel arrays (also referred to as a pixel patch) of a video frame. A pixel patch can be any arbitrary shape or pattern such as (but not limited to) a yxz pixel array, including y pixels horizontally by z pixels vertically from the video frame. A pixel can include color values, such as a red, a green, and a blue value and intensity values. The color values for a pixel can be represented by an eight-bit binary value for each color. Other suitable color values that can be used to represent colors of a pixel include luma and chroma (Y, Cb, Cr, also called YUV) values or any other suitable color values.

SOC 112 may derive a mean value for each cue. The mean value may be a 4-bit data record representative of the cue. The display device may generate the cue by aggregating the average value for each pixel patch and adding a timestamp that corresponds to the frame from which the pixel patches were obtained. The timestamp may correspond to epoch time (e.g., which may represent the total elapsed time in fractions of a second since midnight, Jan. 1, 1970), a predetermined start time, an offset time (e.g., from the start of a media being presented or when the display device was powered on, etc.), or the like. The cue may also include metadata, which can include any information about media being presented, such as a program identifier, a program time, a program length, or any other information.

In some examples, a cue may be derived from any number of pixels patches obtained from a single video frame. Increasing the quantity of pixel patches included in a cue increases the data size of the cue, which may increase the processing load of the display device and the processing load of one or more cloud networks that may operate to identify content. For example, a cue derived from 5 pixel patches may correspond to 600-bits of data (24-bits per pixel patch times 5 pixel patches) not including the timestamp and any metadata. Increasing the quantity of video patches obtained from a video frame may increase the accuracy of boundary detection and content identification at the expense of increasing the processing load. Decreasing the quantity of video patches obtained from a video frame may decrease the accuracy of boundary detection and content identification while also decreasing the processing load of the display device. The display device may dynamically determine whether to generate cues using more or less pixel patches based on a target accuracy and/or processing load of the display devices.

Unknown cues may be compared to known cues of known media stored in database 156 to identify the media segment corresponding to the unknown cue. Media device may use a distance algorithm (e.g., Euclidean, Cosine, Haversine, Minkowski, etc.) or other matching algorithm to identify a closest known cue to an unknown cue. If the distance is less than a threshold distance, SOC 112 may assign the identifier of the known cue to the unknown cue thereby identifying the media segment that the unknown cue was derived from. SOC 112 may retrieve additional information associated with identifier. Cue database 156 may be a component of computing device 104 (e.g., stored in memory 128 or other memory of computing device 104 (not shown)) or may be a remote component (as shown).

Computing device 104 may determine how to present particular media based on the identification of the media. For instances, if multiple sports programs are being presented at a same time during a multiview media presentation, computing device 104 may mute the sports programs (e.g., so as to reduce confusion when multiple audio channels are presented at a same time) or enable the audio component of only the sports program likely to be of interest to the user (e.g., such as the user's home team, etc.) using localized audio. The user of computing device 104 may identify media segments of interest (e.g., using one or more keywords, titles, etc.) and identify how the media segments are to be presented (e.g., in a multiview media presentation, using localized audio, muted, in a standard non-multiview media presentation, etc.). When computing device 104 identifies a media segment of interest, the media devices may present the media according to the user selection. Alternatively, or additionally, computing device 104 may receive an indication as to how particular media segments are to be presented in particular contexts (e.g., in a multiview media presentation, non-multiview media presentation, etc.).

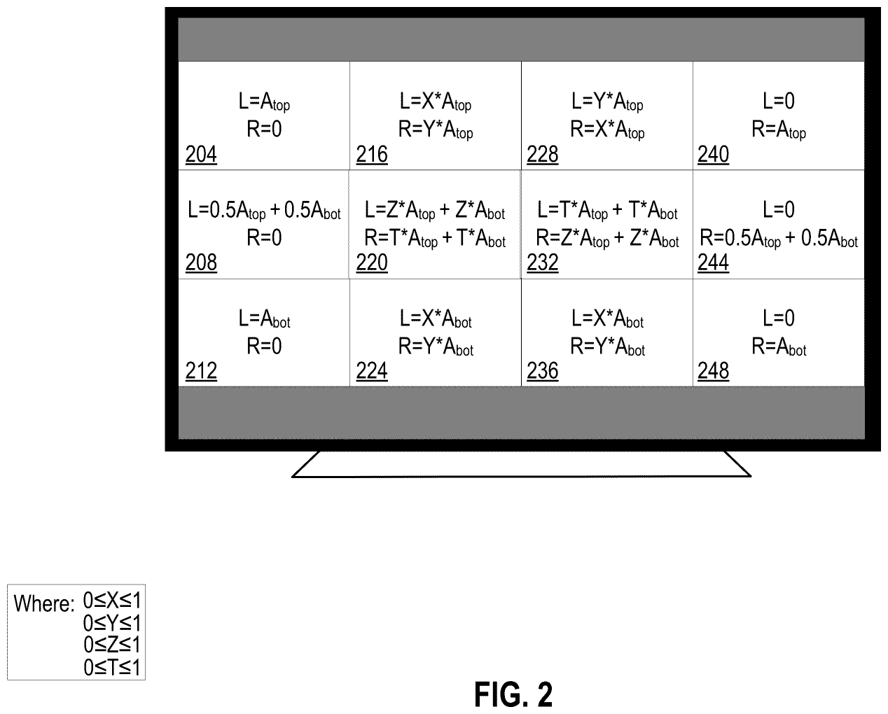

FIG. 2 illustrates an example of modifications to an audio component of media to synchronize with spatial perception of the audio component with the spatial location of a video component during a multiview presentation according to aspects of the present disclosure. A multiview media presentation may include two or more media segments presented at a same time. A media device (e.g., such as computing device 104 of FIG. 1) can be configured to present any number of media segments at a same time. In some examples, a media device may present the two or more media segments in a grid pattern. For instance, as shown, media device 202 is presenting 12 media segments at a same time in three rows of four media segments. Each media segment is presented in a (approximately same size). In other examples, media device 202 may present media segments using other patterns, orientations, sizes, etc.

The media device 202 may be configured to present localized audio that modifies the audio component of a selected media segment so that the modified audio segment is perceived by a user as originating from the location in which the selected media segment is presented on media device 202. A user may operate directional pad on a remote to select a particular media segment with the currently selected media segment highlighted to indicate that the media segment is selected (e.g., by presenting the currently selected media segment in a larger size, higher frame rate or refresh rate, superimposing a symbol on the currently selected media segment, adding a border around currently selected media segment, combinations thereof, and/or the like). Media device 202 may then modify the audio component of the currently selected media segment.

Media device 202 may modify the audio component using a vertical modification (e.g., via a vertical head-related transfer function, machine-learning model approximating or implementing a head-related transfer function, etc.). Since the head-related transfer function is monaural, the vertical modification may be applied to each audio channel separately (as shown). Alternatively, the audio component may be converted to a monoaural (e.g., single channel audio, etc.) and processed using the vertical modification. The vertical modification may be based on the location of speakers of media device 202. If the speakers are the bottom of media device 202, then A_{bot} (e.g., bottom audio), may not be modified by the vertical modification as it will already be perceived as originating at the bottom of media device 202. If the speakers are the top of media device 202, then Aₜₒₚ (e.g., top audio), may not be modified by the vertical modification as it will already be perceived as originating at the bottom of media device 202, etc.)

Media device 202 may determine a minimum vertical modification (e.g., A_{bot}) corresponding to the translation of the audio component of the lowest media segments presenting on media device 202 (e.g., media segments 212, 224, 236, and 248, etc.) and/or maximum vertical modification (e.g., Aₜₒₚ) corresponding to the translation of audio component of the highest media segments presenting on media device 202 (e.g., media segments 204, 216, 228, and 240, etc.). Media device 202 may express the audio component of media segments being presented at the lowest portion of media device 202 such as media segments 212, 224, 236, and 248 in terms of the minimum vertical modification (e.g., A_{bot}). Media device 202 may express the audio component of media segments being presented at the lowest portion of media device 202 such as media segments 204, 216, 228, and 240 in terms of the maximum vertical modification (e.g., Aₜₒₚ). By defining a minimum vertical modification and/or maximum vertical modification, media device 202 may reduce the execution of the head-related transfer function that defines the vertical modification to reduce processing resources needed to generate localized audio. Alternatively, media device 202 may define a location space for each media segment of the multiview media presentation and execute the head-related transfer function to define a vertical modification for each location space.

For example, the audio component of media segments presenting at the bottom of media device 202 may not be modified (if the bottom of media device 202 is proximate to the speakers) or may be modified according to the minimum vertical modification (e.g., A_{bot}). The audio component of media segments presenting at the top of media device 202 may not be modified (if the bottom of media device 202 is proximate to the speakers) or may be modified according to the maximum vertical modification (e.g., Aₜₒₚ). The audio component of media segments between the top of media device 202 and the bottom of media device 202 may be represented as some value relative to Aₜₒₚ and A_{bot}. For instance, media segment 208 and 244 presenting in the middle of media device 202 may be represented as 0.5*A_{bot}+0.5*A_{bot}. The channel (left or right) being presented is based the horizontal location of the media segment with media segment 208 setting the right channel to zero and media segment 244 setting the left channel to zero.

Media device 202 may modify the audio component using horizontal modification by reducing left channel and/or right channel of the audio component. The horizontal modification may cause the modified audio component to be perceived as originating to the left or to the right of the center of the media device (and/or to the left or to the right of the user). Media device 202 may determine the degree of horizontal modification based on the quantity of media segments being presented in each row of the grid pattern. For instance, for two media segments, media device 202 may reduce the left channel to zero causing the audio to be presented from only the right speaker to cause the audio component to be perceived as originating from the right side. Media device 202 may reduce the right channel to zero causing the audio to be presented from only the left speaker to cause the audio component to be perceived as originating from the left side.

For more than two media segments per row, media device 202 may present the audio component of the left-most media segment by reducing the right speaker to zero and may present the audio component of the right-most media segment by reducing the left speaker to zero. For media segments between the left-most and the right-most media segments, media device 202 may scale the left channel and the right channel by some proportional value (between 0 and 1 per channel) to determine the degree in which the left speaker and the right speaker should be reduced. For example, the horizontal modification of audio component of media segments 216 (which is left of center, but not left-most), media device 202 may reduce the right channel by Y (e.g., where 0≤Y≤1) and reduce the left channel by X (e.g., where 0≤Y≤X≤1). Since media segment 216 is left of center, the right channel may be reduced by more than the left channel (e.g., where X=0.75 and Y=0.25, etc.) so that the sound is perceived as originating to the left of center, but not left-most. For media segments that are right of center (e.g., media segment 228, etc.), the left channel may be reduced by more than the right channel so that the sound is perceived as originating to the right of center, but not right-most. Media segments 220 and 232 may be scaled using Z ant T (where 0≤Z≤1 and 0≤T≤1) enable sound variations at locations between the left-most media segment, the right-most media segments, the bottom-most media segments, and the top-most media segments.

The numerical values shown for each media segment 204-248 are by way of example only to indicate how left channel and right channel may scale with location of the media segments to provide localized audio. Media device 202 may derive the left channel and right channel for each media segment depending on the quantity of media segments presented and the relative position of each media segment. Other such values may be used for the left channel and/or the right channel.

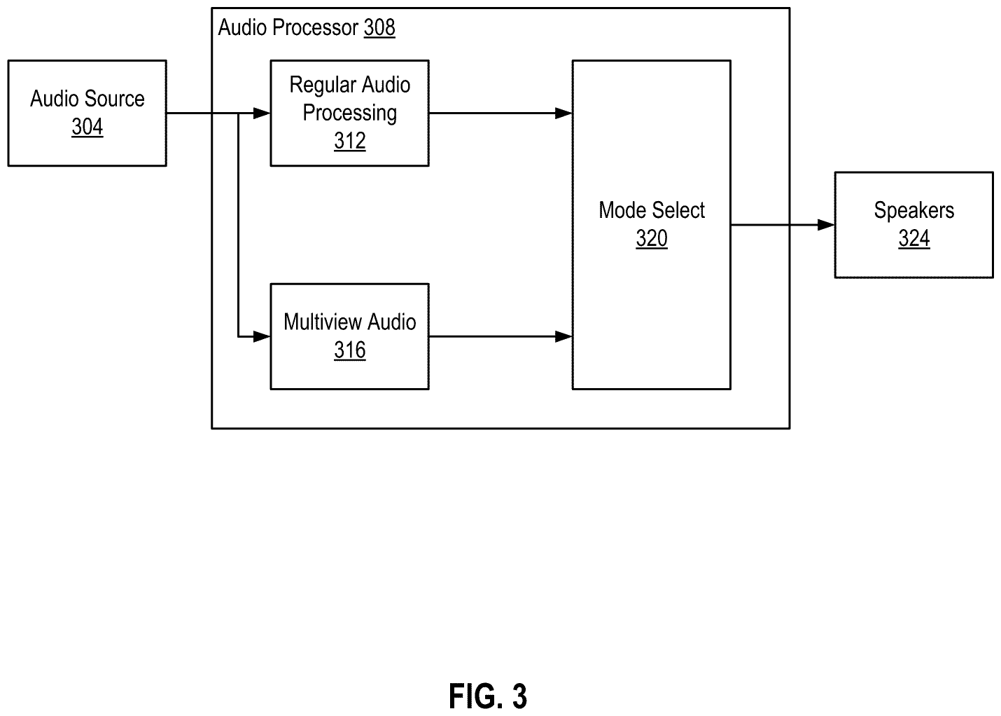

FIG. 3 illustrates a block diagram of an example audio processor for multiview presentation according to aspects of the present disclosure. Audio source 304 may output an audio stream to audio processor 308 for processing before being output to speakers. Audio processor 308 may a component of the same device that audio source 304, an external device (e.g., such as a receiver/amplifier, etc.), etc. or the like. Audio processor may include a mode select that determines how audio from audio source 304 will be processed. For instance, audio processor 308 may determine whether to process audio from audio source using regular audio processing 321 or using multiview audio 316. Audio processor may pass the audio from the selected processor (e.g., audio processing 321 and multiview audio 316, etc.) to speakers 324. Alternative, audio processor 308 may process the audio from audio source 304 in parallel (e.g., at approximately the same time, etc.) to enable fast switching between regular audio processing 321 and multiview audio 316. In those instances, mode select 320 may receive the audio from both regular audio processing 321 and multiview audio 316 and pass the audio from the selected processor (e.g., regular audio processing 321 or multiview audio 316) to speakers 324.

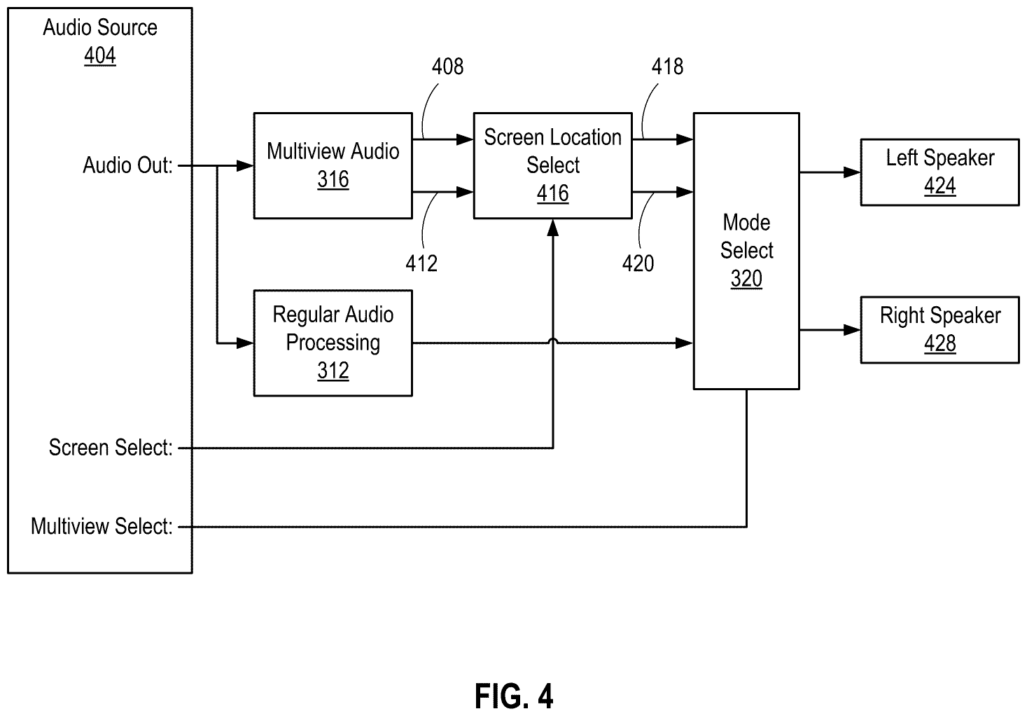

FIG. 4 illustrates a block diagram of an example audio processor for multiview presentation with height virtualization according to aspects of the present disclosure. A multiview media presentation may include one or more media segments presented simultaneously in a grid pattern (e.g., with X rows and Y columns of media segments). In the example of FIG. 4 there are four media segments in the multiview media presentation (e.g., presented in a 2×2 grid). Audio source 404 may output (e.g., as audio out) audio segments (or streams) for each of one or more media segments being presented simultaneously. Audio source may also output one or more control signals such as Multivew Select (e.g., indicating whether the audio processor is to output multiview audio 316 or regular audio processing 312, etc.), Screen Select (e.g., identifying the audio source of the selected media segment that is to be presented), etc. Multiview audio 316 may perform vertical modifications on the audio received from audio source 404 and output an audio signal representing the audio of the media segment based on a maximum vertical modification (e.g., audio signal 408, which includes a modified version of the audio output that is configured to be perceived as originating from a top portion of the media device) and an audio signal representing the minimum vertical modification (e.g., audio signal 412, which includes a modified version of the audio output that is configured to be perceived as originating from a bottom portion of the media device).

Screen location select 416 may receive a Screen Select signal from audio source 404 signal identifying a selected media segment. In response, Screen location select 416 may modify the audio component of the selected media segment based on audio signal 408, audio signal 412, and a horizontal modification. Screen location select 416 may define a first modified audio component based on a vertical location of the selected media segment. The first modified audio component by be a combination of audio signal 408 (e.g., containing a modified audio component configured to be perceived as originating from the top portion of the media device) and audio signal 412 (e.g., containing a modified audio component configured to be perceived as originating from the bottom portion of the media device). If the selected media segment is positioned at the top portion of the media device, then audio signal 408 may be set to 1 (e.g., such that the first modified audio component includes 100% of audio signal 408) and audio signal 412 may be set to zero (e.g., such that the first modified audio component includes 0% of audio signal 412). If the selected media segment is positioned at the bottom portion of the media device, then audio signal 412 may be set to 1 (e.g., such that the first modified audio component includes 100% of audio signal 412) and audio signal 408 may be set to zero (e.g., such that the first modified audio component includes 0% of audio signal 408). If the selected media segment is positioned at the middle of the media device, then audio signal 408 may be set to the same value as audio signal 412 (e.g., such that the first modified audio component includes an equal percentage of audio signal 408 and audio signal 412. If the selected media segment is positioned between the middle of the media device and the top portion of the media device may include a greater portion of audio signal 408 and a smaller portion of audio signal 412 the further the media segment is from the middle (e.g., with audio signal 408 eventually equaling 1 at the top portion of the media device and audio signal 412 equaling 0). If the selected media segment is positioned between the middle of the media device and the bottom portion of the media device may include a greater portion of audio signal 412 and a smaller portion of audio signal 408 the further the media segment is from the middle (e.g., with audio signal 412 eventually equaling 1 at the top portion of the media device and audio signal 408 equaling 0).

The audio processor is configured to present the modified audio component using a speaker positioned on the left side of the media device (or to the left thereof) and a speaker positioned on the right side of the media device (or to the right thereof). Screen location select 416 may output audio signal 418 representing an intensity (e.g., representing a presentation volume) of the first modified audio component that is to be presented by the left speaker (referred to as the left channel) and audio signal 420 representing an intensity of the first modified audio component that is to be presented by the right speaker (referred to as the right channel).

If the selected media segment is positioned at the left-most portion of the media device, then the intensity of audio signal 418 (e.g., representing the portion of the first modified audio component that is to be presented over the left channel) may be set to 1 (e.g., such that the first modified audio component includes 100% of audio signal 418) and the intensity of audio signal 420 (e.g., representing the portion of the first modified audio component that is to be presented over the right channel) may be set to zero (e.g., such that the first modified audio component includes 0% of audio signal 420). If the selected media segment is positioned at the right-most portion of the media device, then the intensity of audio signal 420 may be set to 1 (e.g., such that the first modified audio component includes 100% of audio signal 420) and the intensity of audio signal 418 may be set to zero (e.g., such that the first modified audio component includes 0% of audio signal 418). If the selected media segment is positioned at the middle of the media device, then the intensity of audio signal 418 may be set to the same intensity as audio signal 420 (e.g., such that first modified audio component may be presented equally over the left channel and the right channel). If the selected media segment is positioned between the middle of the media device and the left-most portion of the media device then the intensity of audio signal 418 may be increased and the intensity of audio signal 420 may be decreased the further the media segment is from the middle (e.g., with audio signal 418 eventually equaling 1 at the top portion of the media device and audio signal 420 equaling 0). If the selected media segment is positioned between the middle of the media device and the right-most portion of the media device then the intensity of audio signal 420 may be increased and the intensity of audio signal 418 may be decreased the further the media segment is from the middle (e.g., with audio signal 420 eventually equaling 1 at the top portion of the media device and audio signal 418420 equaling 0). Screen location select may output audio signal 418 representing the portion of the first modified audio component that is to be presented over the left channel and audio signal 420 representing the portion of the first modified audio component that is to be presented over the right channel to mode select 320.

Mode select 320 may receive a Multiview Select control signal from audio source 404. If the Multiview Select indicates multiview media presentation is activated, then mode select 320 may output audio signal 418 to left speaker 424 audio signal 428 to right speaker 428. If the Multiview Select indicates multiview media presentation is not activated, then mode select 320 may output the regularly processed audio (e.g., regular audio processing 312).

In some instances, multiview audio 316 and screen location select 416 may output a single audio signal comprising the audio signals of both 408 and 412 (for multiview audio 316) and 418 and 420 (for screen location select 416).

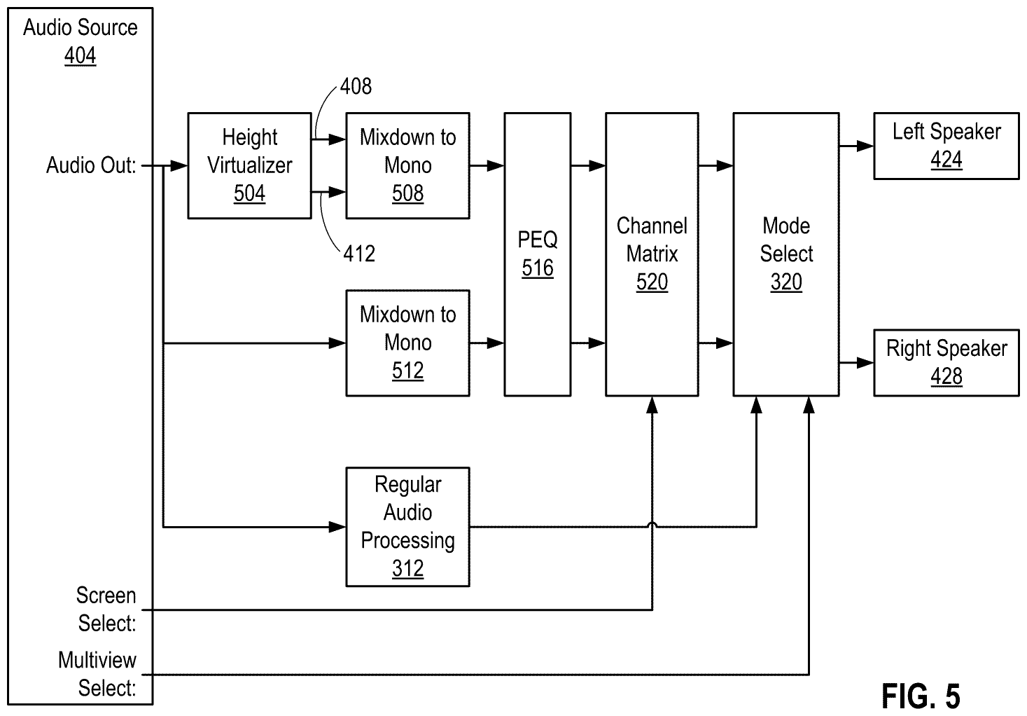

FIG. 5 illustrates a block diagram of another example audio processor for multiview presentation with height virtualization according to aspects of the present disclosure. The audio processor may receive an audio output from audio source 404 that includes the audio component of one or more media segments. The audio output may be received by height virtualizer 504, mixdown to mono 512, and regular audio processing 312. Height virtualizer 504 may perform a vertical modification and output audio signal 408 (e.g., which includes a modified version of the audio output that is configured to be perceived as originating from a top portion of the media device) and audio signal 412 (e.g., which includes a modified version of the audio output that is configured to be perceived as originating from a bottom portion of the media device) to mixdown to mono 508. Mixdown to mono 508 may modify audio signals 408 and 412 by converting the signals from audio signals including two or more channels (e.g., left, right, etc.) to an audio signal that is monoaural (e.g., single channel). Mixdown to mono 512 may modify the audio output of audio source 404 by converting the signals from audio signals including two or more channels (e.g., left, right, etc.) to an audio signal that is monoaural (e.g., single channel). Mixdown to mono 508 and mixdown to mono 512 may output respective audio signals to PEQ 516. PEQ 516 may include a parametric audio equalizer (PEQ), which may adjust the intensity of the audio signals at various frequencies to improve the audio output by the audio processor.

PEQ 516 may output a first modified audio component (corresponding to a PEQ adjusted version of the audio signal received from mixdown to mono 508) and a second modified audio component (corresponding to a PEQ adjusted version of the audio signal received from mixdown to mono 512) to channel matrix 520. Channel matrix 520 may perform a horizontal modification of the first modified audio component and/or the second modified audio component (e.g., using processes that are similar to or the same as screen location select 416 of FIG. 4) to generate a localized audio representation of the audio component of a selected media segment (e.g., based on the received Screen Select control signal). The localized audio representation may include left channel audio signal and a right channel audio signal that are configured to be perceived, when presented, as originating at the location in which the selected media segment is being presented by the media device. Channel matrix 520 may output the left channel audio signal and the right channel audio signal to mode select 320.

Mode select 320 may receive a Multiview Select control signal from audio source 404. If the Multiview Select indicates multiview media presentation is activated, then mode select 320 may output the audio signal representing a left channel to left speaker 424 and the audio signal representing the right channel to right speaker 428. If the Multiview Select indicates multiview media presentation is not activated, then mode select 320 may output the regularly processed audio (e.g., regular audio processing 312) to left speaker 424 and/or right speaker 428.

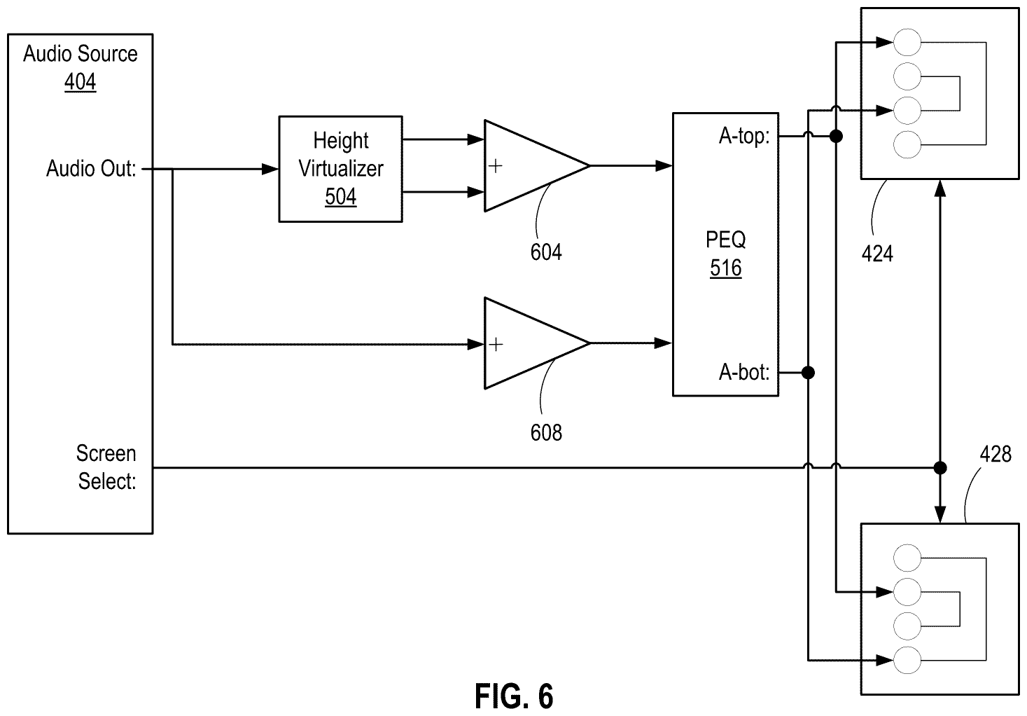

FIG. 6 illustrates an example circuit diagram of an audio processor configured for multiview presentation with height virtualization according to aspects of the present disclosure. Audio processor may receive an audio output from audio source 404. The audio output may be received by height virtualizer 504. Height virtualizer 504 may perform a vertical modification and output height adjusted audio signal 408 (e.g., which includes a modified version of the audio output that is configured to be perceived as originating from a top portion of the media device) and height adjusted audio signal 412 (e.g., which includes a modified version of the audio output that is configured to be perceived as originating from a bottom portion of the media device) to amplifier 604. Amplifier 604 may convert audio signal 408 and audio signal 412 into a monoaural representation (e.g., single channel) and/or amplify audio signal 408 and audio signal 412. The output from amplifier 604, a height adjusted monoaural audio signal (e.g., representing a monoaural of audio signal 408 and audio signal 412), may be received by PEQ 516. PEQ 516 may process the height adjusted monoaural audio signal using a parametric equalizer to adjust the volume of the height adjusted monoaural audio signal at particular frequencies. PEQ 516 may then output a processed monoaural audio signal comprising Aₜₒₚ (e.g., audio configured to be perceived as originating from the top portion of the media device) and A_{bot} (e.g., audio configured to be perceived as originating from the bottom portion of the media device) to left speaker 424 and right speaker 428. Audio source may also output non-height virtualized audio to amplifier 608. Amplifier 608 may convert the non-height virtualized audio to a monoaural representation and/or amplify the monoaural non-height virtualized audio to PEQ 516. PEQ 516 may process the monoaural non-height virtualized audio and output the processed, monoaural non-height virtualized audio as Aₜₒₚ and A_{bot} to left speaker 424 and right speaker 428.

Alternatively, height virtualizer 504 may output a representation of the audio output configured to be perceived as originating at the top portion of the media device (e.g., Aₜₒₚ if the media device speakers are at the bottom of the media device or A_{bot} if the speakers are at the top of the media device) to amplifier 604. The non-height adjusted representation of the audio output (e.g., A_{bot} based on the speakers being at the bottom of the media device or Aₜₒₚ if the speakers are at the top of the media device) may be passed to amplifier 608. Amplifier 604 may output a monaural representation of Aₜₒₚ and amplifier 608 may output a monaural representation A_{bot} to PEQ 516. PEQ 516 may process Aₜₒₚ and A_{bot} using the parametric equalizer to adjust the volume of Aₜₒₚ and A_{bot} at particular frequencies.

Audio source 404 may output a Screen Select control signal to left speaker 424 and right speaker 428 that cause to left speaker 424 and right speaker 428 to present the processed representations of audio signal 408 and audio signal 412 or the processed audio output (without a vertical modification). In some instances, the Screen Select control signal may identify a horizontal modification of the processed monoaural audio (e.g., defining an intensity of Aₜₒₚ and A_{bot} that is to be presented by left speaker 424 and the intensity of Aₜₒₚ and A_{bot} that is to be presented by right speaker 428, etc.). For example, Screen Select may indicate that multiview media presentation is activated and a particular media segment has been selected causing left speaker 424 and right speaker 428 to Aₜₒₚ and A_{bot}, where the Aₜₒₚ and A_{bot} are configured to be perceived by the user as originating at the location in which the particular media segment is being presented. Alternatively, Screen Select may indicate that multiview media presentation is not activated and causing left speaker 424 and right speaker 428 to present the Aₜₒₚ and A_{bot} corresponding to the processed audio output (e.g., processed, monoaural, non-height virtualized audio).

The diagram as shown in FIG. 6 is based left speaker 424 and right speaker 428 being speakers of the media device (e.g., built-in or attached speakers). If the media device is configured to output audio to external speakers (e.g., via wireless protocol such as Bluetooth, Wi-Fi, etc.; a wired protocol such as High-Definition Multimedia Interface (HDMI), an optical cable, etc.; and/or the like), then the audio processor may output Aₜₒₚ and A_{bot} as decoded pulse-code modulation (PCM) to the external speakers. When connected to external speakers, amplifier 604 may output a monaural representation of Aₜₒₚ, which may be output to left speaker 424 and right speaker 428 as decoded PCM and amplifier 608 may output a monaural representation of A_{bot}, which may be output to left speaker 424 and right speaker 428 as decoded PCM.

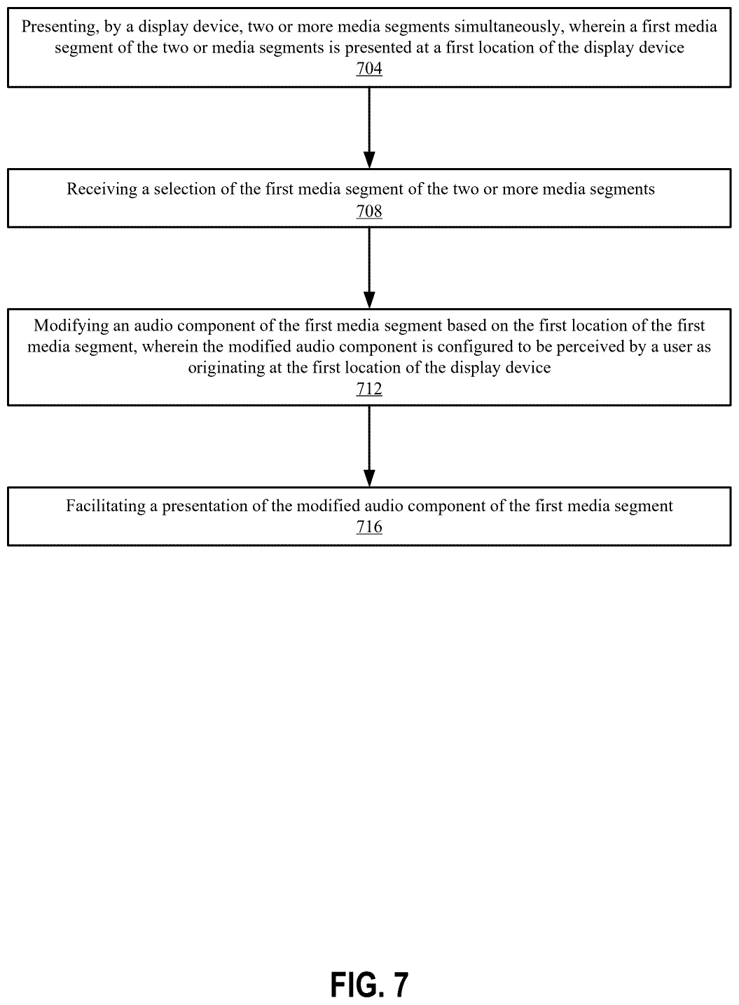

FIG. 7 illustrates a flowchart of an example process for processing the audio component of media to synchronize the spatial perception of the audio component with a video component according to aspects of the present disclosure. At block 704, a display device (e.g., a device configured to present video and audio such as, but not limited to, a television, computing device, mobile device such as a smartphone or tablet, billboard, etc.) may present two or more media segments simultaneously (e.g., referred to as a multivew media presentation). Each media segment may be presented using a portion of the display device of n pixels (e.g., comprising a resolution of x pixels by y pixels). The two or more media segments be a uniform size (e.g., a same resolution) or of varying sizes. The media device may present the two or more media segments in a grid pattern with the two or more media segments presented in one or more rows of media segments. Alternatively, the two or more media segments may be presented in a different orientation (e.g., according to user selected locations on the display device, etc.). A first media segment of the two or media segments may be presented at a first location of the display device.

At block 708, the display device may receive a selection of the first media segment of the two or more media segments. The display device may enable one or more operations to be executed in association with a media segment of the two or more media segments. The display device may receive a selection of any media segment of the two or more media segments and an identification of an operation to execute in association with the selected media segment. Examples of operations include, but are not limited to, modifying a resolution of the video component of the media segment, modifying a refresh rate of the video component, modifying a size of the presentation of the video component, modifying a frame rate of the video segment, modifying a brightness or contrast of the video component, modifying pixel values of pixels of the video component, converting an audio component of the media segment to monaural, converting the audio component to stereo, removing a left audio component, removing a right audio component, modifying the right audio component using a head-related transfer function, modifying the left audio component using a head-related transfer function, modifying a volume of the audio component (e.g., to enable a perception that the audio is closer to the user or further from the user, etc.), adding or removing audio being presented over the audio component (e.g., adding or removing audio corresponding to one or more video segments), filtering the audio component (e.g., dynamically defined bandpass filtering), combinations thereof, and/or the like.

In some instances, when presenting multiview media, the display device may include a default operation associated with the selection of a media segment. For instance, selecting the first media segment of the two or more media segments may cause the display device to modify the audio component of the first media segment to generate a localized audio. Localized audio may include muting other media segments (e.g., media segments other than the first media segment) and modifying the audio component of the first media segment so that the modified audio component will be perceived by the user of the display device as originating at the first location of the display device in which the first media segment is being presented. The display device may execute one or more other operations in addition to the localized audio such as modifying the presentation of the first media segment to provide an indication that the first media segment has been selected. For example, the media device may modify a size of the first media segment, add a border around the first media segment, add a symbol to the first media segment to indicate the first media segment is selected, remove a symbol to indicate the first media segment is selected, modify a frame rate of the first media segment (e.g., increase or decrease the frame rate, etc.), combinations thereof, and/or the like.

At block 712, the display device may modify an audio component of the first media segment based on the first location of the first media segment. The modified audio component is configured to be perceived by a user as originating at the first location of the display device. The modification to the audio component may be determined based on the location of the speakers relative to the display device and/or the location of the user relative to the display device. In some instances, the location of the speakers may be predetermined such as when the speakers are built into the display device or proximate to the display device (e.g., such as a sound bar, etc.). In other instances, the location of the speakers may be determined based on user input (e.g., the user may identify the location of the speakers relative to the display device). In still yet other instances, the location of the speakers may be determined using sensors of the display device. For instance, the display device may detect audio presented by a speaker using a microphone and determine the relative location of the speaker based on the detected audio. Alternatively or additionally, the display device may use other sensors such as, but not limited to, microphones, cameras, transceivers (e.g., to perform triangulation, RSSI, etc.), combinations thereof, and/or the like. The display device may use one or more location algorithms and/or a trained machine-learning model (e.g., as previously described) to identify the location of each speaker.

In some instances, the location of the user may be predetermined based on average viewing distances and angles and the size of the display device. In other instances, the location of the user may be determined based on user input (e.g., the user may identify the location of the user relative to the display device). In still yet other instances, the location of the user may be determined using sensors of the display device. For instance, the display device may detect audio presented the user using a microphone and determine the relative location of the user based on the detected audio. Alternatively, or additionally, the display device may use other sensors such as, but not limited to, microphones, cameras, transceivers (e.g., to perform triangulation, RSSI, etc. of a device proximate to the user, etc.), combinations thereof, and/or the like. The display device may use one or more location algorithms and/or a trained machine-learning model (e.g., as previously described) to identify the location of the user. The display device may determine a horizontal modification and a vertical modification to the audio component.

The display device may define a horizontal modification to the audio component and a vertical modification to the audio component. The horizontal modification may be determined based on the location of first media segment, the location of the speakers, and/or the location of the user. For instance, if the first media segment is on a left portion of the display device, then the display device may present only the left channel of the audio component so that the audio is perceived as coming from the left portion of the display device. For media segments that are being presented closer to the middle of the display device but still on one side of the display device, the display device may reduce a portion of the opposing channel. For instance, if the display device is presented four media segments in a row, then selecting the left most media segment may cause the display device to reduce a characteristic of the right audio channel (e.g., volume, etc.) to zero. Selecting the second media segment from the left (e.g., closer to the middle of the display device, but still on the left side), the media device may reduce the characteristic of right audio channel by a predetermined quantity based on a distance that the center of the media segment is from the middle of the display device (and optionally reduce the characteristic of left channel by an amount). Selecting the right most media segment may cause the display device to reduce the characteristic of the left audio channel to zero. Selecting the second media segment from the right (e.g., closer to the middle of the display device, but on the right side) may cause the media device to reduce characteristic of the left audio channel by a predetermined quantity based on the distance that the center of the media segment is from the middle of the display device (and optionally reduce the right channel by an amount). For example, the second media segment from the left may have a right audio channel presenting at 25% (e.g., of a current volume of the media segment, etc.) and the left audio channel presenting at 75% (e.g., of a current volume of the media segment, etc.).

The display device may define a vertical modification to the audio component using a vertical head-related transfer function using parameters derived from the location of the user. The head-related transfer function may use a monaural version of the audio component. In some instances, the display device may convert the audio component into a mono before implementing the head-related transfer function. The parameters may include, but are not limited to, elevation, azimuth, distance, etc. In some examples, the parameters may be derived from the sensor data and/or other information using one or more algorithms and/or tables (e.g., where one or more sensor measurements may correspond to a parameter value, etc.). Alternatively, the parameters may be derived using a machine-learning model. Examples of machine-learning models or machine-learning algorithms that may be usable to derive the parameters include, but are not limited to, neural networks (recurrent neural networks such as long short term memory (LSTM), etc.; convolutional neural networks such as you only look once (YOLO), etc.; or the like), support vector machines, Naïve Bayes, k-nearest neighbor, linear or non-linear regression models, gradient-boosted decision trees, etc.), spatial clustering of applications with noise (DBSCAN), linear classification, hierarchical clustering, k-means clustering, fuzzy c-means (FCM), expectation-maximization (EM), and/or the like. More generally, machine learning or artificial intelligence methods may include regression analysis, dimensionality reduction, metalearning, reinforcement learning, deep learning, and other such algorithms and/or methods.

In some instances, the display device may include a pre-trained machine-learning model, access a trained machine-learning model stored remotely (e.g., such as in a computing device, server, etc.), and/or the like. Alternatively, the media device may train the machine-learning model. The machine-learning model may be trained using supervised learning, unsupervised learning, semi-supervised learning, transfer learning, reinforcement learning, combinations thereof, or the like. The computing device may train the machine-learning model for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like). The machine-learning model may receive a feature vector derived from sensor data (e.g., normalized, unnormalized, etc.), other information, user input, and/or the like. The machine-learning model may be configured to output the parameters for the head-related transfer function. Alternatively, the machine-learning model may implement the head-related transfer function. The output of the head-related transfer function may be a vertically modified version of the audio component (e.g., a translation of the audio component in the vertical plane) that may be perceived as originating on an upper portion of the display device or a lower portion of the display device.

The modified audio component may be a combination of the vertical modification (e.g., the output from the head-related transfer function or machine-learning model) as adjusted horizontally using the horizontal modification to the audio component. Alternatively, the head-related transfer function may be configured to derive both the vertical modification and the horizontal modification. In those instances, the frequency and intensity of the audio component may be defined to cause the modified audio component to be perceived as originating at the first location of the display device without adjusting the left or right audio channels.

At block 716, the display device may facilitate a presentation of the modified audio component of the first media segment. The presentation of the modified audio channel may be perceived by the user as originating at the first location of the display device.

The display device may receive a selection of a new media segment and in response mute the audio component of the first media segment and modify the audio component of the new media segment based on the location of the presentation of the new media segment on the display device. The modified audio component of the new media segment may be perceived by the user as originating at the location of the presentation of the new media segment on the display device.

The process of FIG. 7 (and/or any of the individual blocks) may continue until the multiview media presentation is terminated or the display device is powered off. For example, a request to terminate the multiview media presentation. The request may include an identification of a particular media segment (e.g., a media segment of the two or more media segments, a particular channel, a particular application of the display device, an interface of the display device, etc.). In response, the display device may determine if the current audio channel being presented corresponds to the particular media segment. If the audio channel being presented does not correspond to the particular media segment, the display device may begin presenting the audio channel corresponding to the particular media segment. For instance, the display device may mute the audio channel that is current being presented and present the audio channel corresponding to the particular media segment. Alternatively, the display device may terminate the audio channel associated with any other media segment and present the audio channel corresponding to the particular media segment.

The display device may present the particular media segment using the full screen of the display device. The display device may terminate the display and processing associated with the other media segments of the two or more media segments. Since the display device is now presenting a single media segment using a full screen of the display device, the display device may present the unmodified version of the audio channel corresponding to the particular media segment.

The display device may receive a request to initiate or terminate a multiview presentation at any time. Upon receiving a request to initiate multiview presentation, the media device may enable selection of the two or more media segments (e.g., a particular media segment, a media segment being broadcast on a particular channel, a particular application of the display device, an interface of the display device, video game console connected to the display device, etc.). For example, the display device may receive an identification of a title of the media segment (e.g., via a search service of the display device, etc.), an identification of a channel (e.g. via the search service, through an alphanumeric input from a remote control associated with the display device), a selection of an application from one or more icons of an interface of the display device, etc.

In some examples, the display device may also receive an identification of a display region of each media segment of the two or more media segments. For example, the display device may receive an identification of a first media segment (e.g., a title of a television program, etc.) with an identification of a location of the display device that is to present the first media segment. The locations that can be selected may be predefined based on the quantity of media segments that are to be presented simultaneously via the multiview presentation. Alternatively, or additionally, the display device may enable selection of pixel regions of the display device for each media segment being presented. For example, the display device may receive an identification of a first media segment along with a selection of pixel addresses such as 0-959 (referring to the horizontal pixels being 959 pixels “wide”), 0-539 (referring to the vertical pixels being 539 pixels “long”). The display device may address pixels from a corner of the display or from any arbitrary location. For example, for a 1080p display device, the address of the top, left most pixel may be addressed as 0,0 (where the first integer represents the horizontal axis and the second integer represent the vertical axis, etc.) and the address of the bottom, right most pixel may be 1919×1079. Alternatively, the address of the pixel in the center of the display device may be addressed as 0,0 (where addresses of the horizontal axis may be negative to represent pixels to the left of center and addresses of the horizontal axis may be positive to represent pixels to the right of center, addresses of the vertical axis may be negative to represent pixels to the below center, and addresses of the vertical axis may be positive to represent pixels to the above center, etc.).

Once the multivew presentation is established, the process may then continue at block 704.

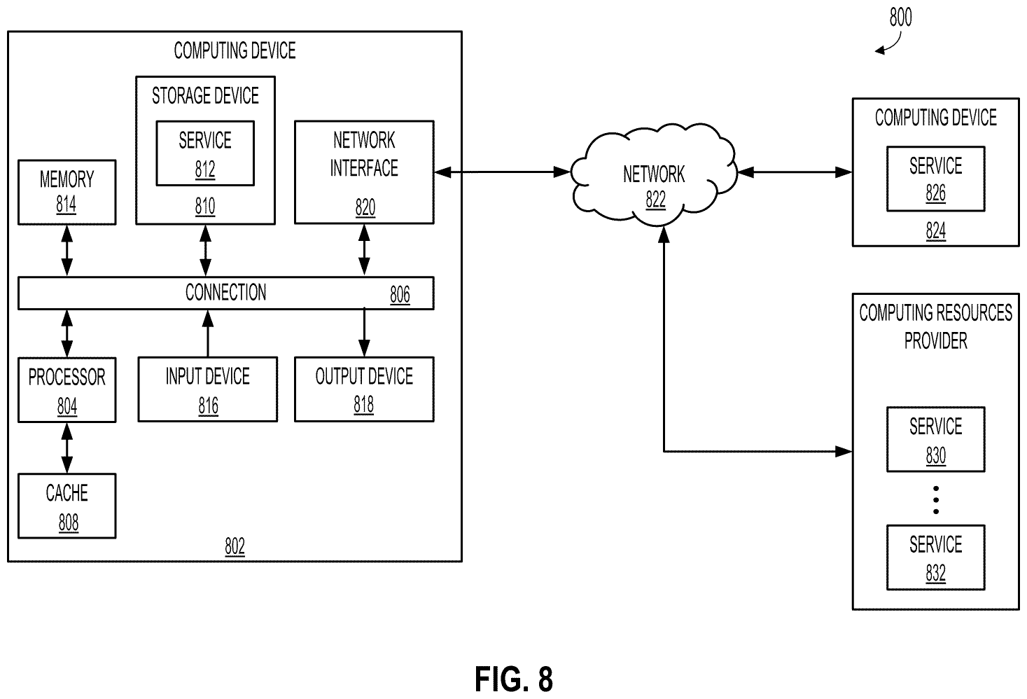

FIG. 8 illustrates an example computing device architecture of an example computing device that can implement the various techniques described herein according to aspects of the present disclosure. The example computing system architecture 800 illustrated in FIG. 8 includes a computing device 802, which has various components in electrical communication with each other using a connection 806, such as a bus, in accordance with some implementations. The example computing system architecture 800 includes a processing unit 804 that is in electrical communication with various system components, using the connection 806, and including the system memory 814. In some embodiments, the system memory 814 includes read-only memory (ROM), random-access memory (RAM), and other such memory technologies including, but not limited to, those described herein. In some embodiments, the example computing system architecture 800 includes a cache 808 of high-speed memory connected directly with, in close proximity to, or integrated as part of the processor 804. The system architecture 800 can copy data from the memory 814 and/or the storage device 810 to the cache 808 for quick access by the processor 804. In this way, the cache 808 can provide a performance boost that decreases or eliminates processor delays in the processor 804 due to waiting for data. Using modules, methods and services such as those described herein, the processor 804 can be configured to perform various actions. In some embodiments, the cache 808 may include multiple types of cache including, for example, level one (L1) and level two (L2) cache. The memory 814 may be referred to herein as system memory or computer system memory. The memory 814 may include, at various times, elements of an operating system, one or more applications, data associated with the operating system or the one or more applications, or other such data associated with the computing device 802.

Other system memory 814 can be available for use as well. The memory 814 can include multiple different types of memory with different performance characteristics. The processor 804 can include any general-purpose processor and one or more hardware or software services, such as service 812 stored in storage device 810, configured to control the processor 804 as well as a special-purpose processor where software instructions are incorporated into the actual processor design. The processor 804 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 804 can be a microprocessor, a microcontroller, a digital signal processor (“DSP”), or a combination of these and/or other types of processors. In some embodiments, the processor 804 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 800, an input device 816 can represent any number of input mechanisms, such as a microphone for speech, a touch-sensitive screen for gesture or graphical input, keyboard, mouse, motion input, pen, and other such input devices. An output device 818 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 800. In some embodiments, the input device 816 and/or the output device 818 can be coupled to the computing device 802 using a remote connection device such as, for example, a communication interface such as the network interface 820 described herein. In such embodiments, the communication interface can govern and manage the input and output received from the attached input device 816 and/or output device 818. As may be contemplated, there is no restriction on operating on any particular hardware arrangement and accordingly the basic features here may easily be substituted for other hardware, software, or firmware arrangements as they are developed.

In some embodiments, the storage device 810 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 810 can include hardware and/or software services such as service 812 that can control or configure the processor 804 to perform one or more functions including, but not limited to, the methods, processes, functions, systems, and services described herein in various embodiments. In some embodiments, the hardware or software services can be implemented as modules. As illustrated in example computing system architecture 800, the storage device 810 can be connected to other parts of the computing device 802 using the system connection 806. In some embodiments, a hardware service or hardware module such as service 812, that performs a function can include a software component stored in a non-transitory computer-readable medium that, in connection with the necessary hardware components, such as the processor 804, connection 806, cache 808, storage device 810, memory 814, input device 816, output device 818, and so forth, can carry out the functions such as those described herein.

The disclosed systems and services can be performed using a computing system such as the example computing system illustrated in FIG. 8, using one or more components of the example computing system architecture 800. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 804 wherein the code is stored in memory such as memory 814 as described herein. One or more of a user device, a provider server or system, a database system, or other such devices, services, or systems may include some or all of the components of the computing system such as the example computing system illustrated in FIG. 8, using one or more components of the example computing system architecture 800 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 828. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 804 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 814 can be coupled to the processor 804 by, for example, a connector such as connector 806, or a bus. As used herein, a connector or bus such as connector 806 is a communications system that transfers data between components within the computing device 802 and may, in some embodiments, be used to transfer data between computing devices. The connector 806 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 814 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 814 can also include magnetic or optical data storage media including read-only (e.g., CD ROM and DVD ROM) or otherwise (e.g., CD or DVD). The memory can be local, remote, or distributed.

As described above, the connector 806 (or bus) can also couple the processor 804 to the storage device 810, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 810. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 806 can also couple the processor 804 to a network interface device such as the network interface 820. The interface can include one or more of a modem or other such network interfaces including, but not limited to those described herein. It will be appreciated that the network interface 820 may be considered to be part of the computing device 802 or may be separate from the computing device 802. The network interface 820 can include one or more of an analog modem, Integrated Services Digital Network (ISDN) modem, cable modem, token ring interface, satellite transmission interface, or other interfaces for coupling a computer system to other computer systems. In some embodiments, the network interface 820 can include one or more input and/or output (I/O) devices. The I/O devices can include, by way of example but not limitation, input devices such as input device 816 and/or output devices such as output device 818. For example, the network interface 820 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the LinuxTM operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 8 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 802 can be connected to one or more additional computing devices such as computing device 824 via a network 822 using a connection such as the network interface 820. In such embodiments, the computing device 824 may execute one or more services 826 to perform one or more functions under the control of, or on behalf of, programs and/or services operating on computing device 802. In some embodiments, a computing device such as computing device 824 may include one or more of the types of components as described in connection with computing device 802 including, but not limited to, a processor such as processor 804, a connection such as connection 806, a cache such as cache 808, a storage device such as storage device 810, memory such as memory 814, an input device such as input device 816, and an output device such as output device 818. In such embodiments, the computing device 824 can carry out the functions such as those described herein in connection with computing device 802. In some embodiments, the computing device 802 can be connected to a plurality of computing devices such as computing device 824, each of which may also be connected to a plurality of computing devices such as computing device 824. Such an embodiment may be referred to herein as a distributed computing environment.

The network 822 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 822 can be wired connections, wireless connections, or combinations thereof. Communications via the network 822 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 822, within the computing device 802, within the computing device 824, or within the computing resources provider 828 can include information, which also may be referred to herein as content. The information may include text, graphics, audio, video, haptics, and/or any other information that can be provided to a user of the computing device such as the computing device 802. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 802 and presented to a user of the computing device 802 using forms that are perceptible via sight, sound, smell, taste, touch, or other such mechanisms. In some embodiments, communications over the network 822 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 802 and/or the computing device 824 can be connected to a computing resources provider 828 via the network 822 using a network interface such as those described herein (e.g., network interface 820). In such embodiments, one or more systems (e.g., service 830 and service 832) hosted within the computing resources provider 828 (also referred to herein as within “a computing resources provider environment”) may execute one or more services to perform one or more functions under the control of, or on behalf of, programs and/or services operating on computing device 802 and/or computing device 824. Systems such as service 830 and service 832 may include one or more computing devices such as those described herein to execute computer code to perform the one or more functions under the control of, or on behalf of, programs and/or services operating on computing device 802 and/or computing device 824.

For example, the computing resources provider 828 may provide a service, operating on service 830 to store data for the computing device 802 when, for example, the amount of data that the computing device 802 exceeds the capacity of storage device 810. In another example, the computing resources provider 828 may provide a service to first instantiate a virtual machine (VM) on service 832, use that VM to access the data stored on service 832, perform one or more operations on that data, and provide a result of those one or more operations to the computing device 802. Such operations (e.g., data storage and VM instantiation) may be referred to herein as operating “in the cloud,” “within a cloud computing environment,” or “within a hosted virtual machine environment,” and the computing resources provider 828 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 828 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 830 and service 832 may implement versions of various services (e.g., the service 812 or the service 826) on behalf of, or under the control of, computing device 802 and/or computing device 824. Such implemented versions of various services may involve one or more virtualization techniques so that, for example, it may appear to a user of computing device 802 that the service 812 is executing on the computing device 802 when the service is executing on, for example, service 830. As may also be contemplated, the various services operating within the computing resources provider 828 environment may be distributed among various systems within the environment as well as partially distributed onto computing device 824 and/or computing device 802.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

As used below, any reference to a series of examples is to be understood as a reference to each of those examples disjunctively (e.g., “Examples 1-4” is to be understood as “Examples 1, 2, 3, or 4”).

Example 1 is a method comprising: presenting, by a display device, two or more media segments simultaneously, wherein a first media segment of the two or media segments is presented at a first location of the display device; receiving a selection of the first media segment of the two or more media segments; modifying an audio component of the first media segment based on the first location of the first media segment, wherein the modified audio component is configured to be perceived by a user as originating at the first location of the display device; and facilitating a presentation of the modified audio component of the first media segment.

Example 2 is the method of example(s) 1 and 3-7, wherein audio components of other media segments of the two or more media segments are muted during presentation of the modified audio component.

Example 3 is the method of example(s) 1-2 and 4-7, wherein the display device includes a left half and a right half, and wherein the modified audio component is configured to be presented by a speaker positioned on a same half of the display device as the first location of the display device.

Example 4 is the method of example(s) 1-3 and 5-7, wherein the audio component is modified using a vertical head-related transfer function to cause the modified audio component to be perceived at a height that is approximately equal to a height of the first location of the display device.

Example 5 is the method of example(s) 1-4 and 6-7, further comprising: receiving a selection of a second media segment of the two or more media segments, the second media segment being presented at a second location of the display device; muting the modified audio component of the first media segment; modifying an audio component of the second media segment based on the second location of the display device, wherein the modified audio component of the second media segment is configured to be perceived by the user as originating at the second location of the display device; and facilitating a presentation of the modified audio component of the second media segment.

Example 6 is the method of example(s) 1-5 and 7, further comprising: receiving a selection of a particular media segment of the two or more media segments; and terminating the presentation of the two or media segments; and presenting the particular media segment using a full screen of the display device.

Example 7 is the method of example(s) 1-6, wherein modifying the audio component includes downmixing the audio component to monoaural.

Example 8 is a system comprising: one or more processors; a non-transitory computer-readable medium storing instructions that when executed by the one or more processors, cause the one or more processors to perform the methods of any of example(s) s 1-7.

Example 9 is a non-transitory computer-readable medium storing instructions that when executed by one or more processors, cause the one or more processors to perform the methods of any of example(s) s 1-7.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process of FIG. 4). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. §112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
presenting, by a display device, two or more media segments simultaneously, wherein a first media segment of the two or media segments is presented at a first location of the display device;
receiving a selection of the first media segment of the two or more media segments;
modifying an audio component of the first media segment based on the first location of the first media segment, wherein the modified audio component is configured to be perceived by a user as originating at the first location of the display device; and
facilitating a presentation of the modified audio component of the first media segment.

2. The method of claim 1, wherein audio components of other media segments of the two or more media segments are muted during presentation of the modified audio component.

3. The method of claim 1, wherein the display device includes a left half and a right half, and wherein the modified audio component is configured to be presented by a speaker positioned on a same half of the display device as the first location of the display device.

4. The method of claim 1, wherein the audio component is modified using a vertical head-related transfer function to cause the modified audio component to be perceived at a height that is approximately equal to a height of the first location of the display device.

5. The method of claim 1, further comprising:
receiving a selection of a second media segment of the two or more media segments, the second media segment being presented at a second location of the display device;
muting the modified audio component of the first media segment;
modifying an audio component of the second media segment based on the second location of the display device, wherein the modified audio component of the second media segment is configured to be perceived by the user as originating at the second location of the display device; and
facilitating a presentation of the modified audio component of the second media segment.

6. The method of claim 1, further comprising:
receiving a selection of a particular media segment of the two or more media segments;
terminating the presentation of the two or media segments; and
presenting the particular media segment using a full screen of the display device.

7. The method of claim 1, wherein modifying the audio component includes downmixing the audio component to monoaural.

8. A system comprising:
one or more processors; and
a non-transitory computer-readable medium storing instructions that when executed by the one or more processors, cause the one or more processors to perform operations including:
presenting, by a display device, two or more media segments simultaneously, wherein a first media segment of the two or media segments is presented at a first location of the display device;
receiving a selection of the first media segment of the two or more media segments;
modifying an audio component of the first media segment based on the first location of the first media segment, wherein the modified audio component is configured to be perceived by a user as originating at the first location of the display device; and
facilitating a presentation of the modified audio component of the first media segment.

9. The system of claim 8, wherein audio components of other media segments of the two or more media segments are muted during presentation of the modified audio component.

10. The system of claim 8, wherein the display device includes a left half and a right half, and wherein the modified audio component is configured to be presented by a speaker positioned on a same half of the display device as the first location of the display device.

11. The system of claim 8, wherein the audio component is modified using a vertical head-related transfer function to cause the modified audio component to be perceived at a height that is approximately equal to a height of the first location of the display device.

12. The system of claim 8, wherein the operations further include:
receiving a selection of a second media segment of the two or more media segments, the second media segment being presented at a second location of the display device;
muting the modified audio component of the first media segment;
modifying an audio component of the second media segment based on the second location of the display device, wherein the modified audio component of the second media segment is configured to be perceived by the user as originating at the second location of the display device; and
facilitating a presentation of the modified audio component of the second media segment.

13. The system of claim 8, wherein the operations further include:
receiving a selection of a particular media segment of the two or more media segments;
terminating the presentation of the two or media segments; and
presenting the particular media segment using a full screen of the display device.

14. The system of claim 8, wherein modifying the audio component includes downmixing the audio component to monoaural.

15. A non-transitory computer-readable medium storing instructions that when executed by one or more processors, cause the one or more processors to perform operations including:
presenting, by a display device, two or more media segments simultaneously, wherein a first media segment of the two or media segments is presented at a first location of the display device;
receiving a selection of the first media segment of the two or more media segments;
modifying an audio component of the first media segment based on the first location of the first media segment, wherein the modified audio component is configured to be perceived by a user as originating at the first location of the display device; and
facilitating a presentation of the modified audio component of the first media segment.

16. The non-transitory computer-readable medium of claim 15, wherein audio components of other media segments of the two or more media segments are muted during presentation of the modified audio component.

17. The non-transitory computer-readable medium of claim 15, wherein the display device includes a left half and a right half, and wherein the modified audio component is configured to be presented by a speaker positioned on a same half of the display device as the first location of the display device.

18. The non-transitory computer-readable medium of claim 15, wherein the audio component is modified using a vertical head-related transfer function to cause the modified audio component to be perceived at a height that is approximately equal to a height of the first location of the display device.

19. The non-transitory computer-readable medium of claim 15, wherein the operations further include:
receiving a selection of a second media segment of the two or more media segments, the second media segment being presented at a second location of the display device;
muting the modified audio component of the first media segment;
modifying an audio component of the second media segment based on the second location of the display device, wherein the modified audio component of the second media segment is configured to be perceived by the user as originating at the second location of the display device; and
facilitating a presentation of the modified audio component of the second media segment.

20. The non-transitory computer-readable medium of claim 15, wherein the operations further include:
receiving a selection of a particular media segment of the two or more media segments;
terminating the presentation of the two or media segments; and
presenting the particular media segment using a full screen of the display device.
